(19) United States
(12) Patent Application Publication
(10) Pub. No.: US 2026/0057391 A1
(43) Pub. Date: Feb. 26, 2026

(54) METHODS FOR CONNECTING A PARTNER ECOSYSTEM

(71) Applicant: Salesforce, Inc., San Francisco, CA (US)

(72) Inventors: Rebecca Greenberg, San Francisco, CA (US); Rajesh Balasubramanian, San Francisco, CA (US); Billy Ma, San Francisco, CA (US); Shreyans Jain, Bellevue, WA (US); Kanan Garg, New York, NY (US); Timothy Bowker, Indianapolis, IN (US); Kasthuri Periyakoil, San Francisco, CA (US); Lisa Kaplan, San Francisco, CA (US); David Aden, Remote, FL (US); Jiyoung Baek, Remote, CA (US); Vivek Dodeja, San Francisco, CA (US); Jose Garcia, San Francisco, CA (US)

(73) Assignee: Salesforce, Inc., San Francisco, CA (US)

(21) Appl. No.: 19/214,019

(22) Filed: May 20, 2025

Related U.S. Application Data
(60) Provisional application No. 63/687,299, filed on Aug. 26, 2024.

(51) Int. Cl. G06Q 30/01; G06F 21/51; G06F 21/60

(52) U.S. Cl. CPC G06Q 30/01; G06F 21/51; G06F 21/604

(57) ABSTRACT

A hub-and-spoke architecture for bidirectional connections between a first vendor and a second vendor, wherein the second vendor functions as a partner on a spoke to the first vendor functioning as a hub, an event-based architecture configured to transmit data between the first vendor and the second vendor based on a predefined event, a metadata sharing module configured to share authorized organizational metadata between the vendor and the one or more partners, wherein the metadata sharing module enables the first vendor to submit a request for access to one or more requested data fields from the second vendor, enables the second vendor to approve the request, to identify one or more corresponding data fields corresponding to the one or more requested data fields, and to integrate the granted data fields into the vendor's CRM system.

### CROSS REFERENCE TO RELATED APPLICATIONS

This application claims the benefit of U.S. Provisional Application No. 63/687,299 filed Aug. 26, 2024.

### TECHNICAL FIELD

One or more implementations relate to the field of database systems, and more specifically, to securely sharing database records in the context of a partner ecosystem in a communication platform.

### BACKGROUND

Customer relationship management (CRM) software has become an indispensable tool for businesses seeking to enhance customer interactions, streamline sales processes, and improve overall customer satisfaction. Traditional CRM systems often rely on centralized databases to store customer information, enabling sales, marketing, and customer service teams to access and manage data. However, these systems can suffer from limitations such as data silos, fragmented customer views, and difficulties in adapting to evolving customer behaviors and communication channels. In modern business ecosystems, collaboration between partner vendors can be crucial for delivering comprehensive solutions to customers. However, these partners often utilize disparate CRM systems, leading to significant challenges in seamlessly sharing and synchronizing critical customer information. This lack of interoperability results in data silos, redundant data entry, delayed response times, and an inability to provide unified customer experience.

Existing methods for data exchange between vendor partners, such as manual data transfers or basic file exports, can be inefficient, error-prone, and lack real-time updates. Consequently, there is a need for an improved system and method that enables secure and efficient information sharing between partner vendors utilizing separate CRM platforms, thereby enhancing collaboration and improving customer satisfaction in order to provide a more holistic and dynamic approach to customer relationship management. Accordingly, it is desirable to facilitate data integration across different platforms or systems with improved security and to limit unauthorized access to shared and unshared data.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating an exemplary partner connection system for sharing data records between multiple partner systems over a communications network according to some example implementations;

FIG. 2 is a block diagram illustrating an exemplary partner connect architecture that may be implemented or otherwise performed securely sharing data records with one or more partners according to some example implementations;

FIG. 3 depict an exemplary authentication sequence for an exemplary partner connect architecture that may be implemented or otherwise performed securely sharing data records with one or more partners according to some example implementations;

FIG. 4 illustrates a data structure illustrating relationships and attributes of data entities for an exemplary partner connect architecture that may be implemented or otherwise performed securely sharing data records with one or more partners according to some example implementations;

FIG. 5A is a block diagram illustrating an electronic device according to some example implementations; and

FIG. 5B is a block diagram of a deployment environment according to some example implementations.

The exempliﬁcations set out herein illustrate preferred embodiments of the invention, and such exemplifications are not to be construed as limiting the scope of the invention in any manner.

### DETAILED DESCRIPTION

The subject matter described herein generally relates to securely sharing data records with one or more partners and the need for seamless information sharing within complex partner ecosystems, particularly those utilizing disparate Customer Relationship Management (CRM) platforms. Traditional Partner Relationship Management (PRM) solutions often fail to provide adequate interoperability, leading to fragmented data, inefficient collaboration, and hindered customer experiences. The currently disclosed systems and methods introduce a novel approach that extends core PRM functionalities by enabling the connection of multiple partners across diverse CRM environments, thereby eliminating the need for cumbersome manual data transfers and fostering real-time visibility into shared processes. A primary use case involves scenarios where multiple partners collaborate on a single customer engagement, each operating within their respective CRM systems. The invention facilitates the exchange of only essential, pre-defined information, ensuring data security and minimizing information overload.

To achieve this interoperability, the system employs point-to-point, event-based architecture. This architecture allows for the publication of specific events to designated endpoints, such as an ‘X-Website’ API, enabling partners to integrate with the system in a flexible and adaptable manner. Furthermore, the system streamlines the setup process through automated authentication between partner organizations, significantly reducing the burden on system administrators. The system can employ a plug-and-play architecture, offering seamless integration between common or disparate CRM systems and configurations. In some exemplary embodiments, the vendor can retain control over field mapping, dictating which data elements are shared, and the partner complies with these specifications ensuring consistency and data integrity across the ecosystem.

Unlike traditional data synchronization methods, the exemplary event-based architecture avoids the limitations of continuous data replication. Instead, it enables the selective transmission of information based on predefined thresholds and customizations. This allows customers to tailor the system to their specific needs, choosing when and what information is shared across the partner ecosystem. The system also includes mechanisms to guarantee the order of event processing, ensuring data consistency and accuracy. By providing a customizable and event-driven approach to information sharing, the invention empowers partners to collaborate more effectively, improve customer satisfaction, and drive mutual business growth.

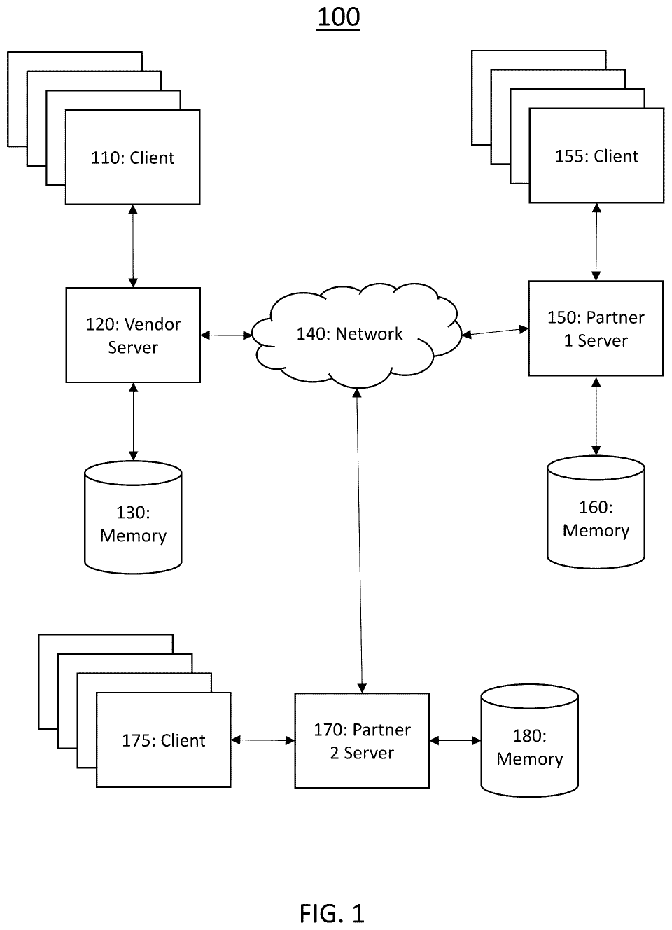

Turning now to FIG. 1, an exemplary partner connection system 100 for sharing data records between multiple partner systems 120, 150, 170 over a communications network 140 is shown. It should be appreciated that FIG. 1 depicts a simplified representation of the partner connection system 100 for purposes of explanation and is not intended to be limiting. In this regard, the communications network 140 may be realized as the Internet or any sort or combination of a wired and/or wireless computer network, a cellular network, a mobile broadband network, a radio network, or the like. While the exemplary embodiment describes a partner connection system 100 including one vendor server 120, a first partner server 150 and a second partner server 170 with second partner clients 175, the partner connection system 100 can be configured such that any server can be configured as a vendor server and/or a partner server, with the partner connection system 100 capable of having more than one vendor server application operating simultaneously. For purposes of explanation, the one or more servers 120, 150, 170 may alternatively be referred to herein as an application server.

The partner connection system 100 generally includes a vendor server 120 and one or more partner servers 150, 170, which generally represent a server computing device, server computing system or another combination of processing logic, circuitry, hardware, and/or other components that are coupled to the network 140 and configurable to support instances of CRM applications that support interactions between users of different client devices 110, 155, 175. In this regard, the partner servers 150, 170 generally include processing systems, which may be implemented using any suitable processing system and/or device, such as, for example, one or more processors, central processing units (CPUs), controllers, microprocessors, microcontrollers, processing cores and/or other hardware computing resources configured to support the operation of the processing system described herein. The processing system may include or otherwise access a data storage element, or memory 130, 160, 180, capable of storing programming instructions for execution by the processing system, that, when read and executed, are configurable to cause the processing system to create, generate, or otherwise facilitate the CRM application based at least in part upon code and other data that is stored or otherwise maintained by the memory 130, 160, 180, and support the subject matter described herein. In one or more implementations, the programming instructions cause the processing system to create, generate, or otherwise facilitate an application platform that generates, supports or otherwise facilitates instances of the CRM application using data that is stored or otherwise maintained by a database in a memory 130, 160, 180.

In exemplary embodiments, the vendor server 120 can perform a CRM application, offering services to one or more CRM clients 110. The CRM application can be employed to facilitate a dynamic partner ecosystem through a hub-and-spoke, event-based architecture, automating authentication and data sharing to streamline co-selling and collaboration between the vendor server 120 and the one or more partner servers 150, 170. This architecture allows the application server 120 and one or more partner servers 150, 170 to connect bidirectionally, sharing authorized organizational metadata and read-only records. The architecture can be used to automate the process of requesting and granting access to specific data fields, ensuring secure and controlled information exchange, while limiting authentication scope to prevent unauthorized API access and maintain data integrity. This approach significantly reduces the setup time for partner integrations by automating key processes like connection establishment and permission granting.

Hub-and-spoke architecture can effectively facilitate bidirectional connections between CRM servers, particularly when one server acts as a vendor server 120 and the other servers act as partner servers 150, 170 on a spoke. In this configuration, the vendor server 120, performing the CRM application, functions as the hub, establishing a central point of data and communication for the partner connection system 100. At least one partner server 150, operating as a spoke, connects to this hub, enabling the exchange of information and resources. This setup allows for streamlined data flow, where the hub can distribute information to and receive data from the spoke. Crucially, the bidirectional nature of this architecture ensures that the partner server 150 can also initiate communication and data transfer back to the hub, fostering a collaborative and interconnected relationship. This model allows for centralized management and control by the vendor server 120, while also enabling the partner server 150 to actively participate in the overall network. In some exemplary embodiments, a metadata sharing module can be configured to share authorized organizational metadata between the vendor server 120 and the one or more partner servers 150, 170, wherein the metadata sharing module enables the vendor server 120 to submit a request for access to one or more requested data fields from the one or more partner servers 150, 170, enables the partner server 150, 170 to approve the request, to identify one or more corresponding data fields corresponding to the one or more requested data fields, and to enable the partner server 150, 170 to grant access to the vendor server 120 to the one or more corresponding data fields.

In some exemplary embodiments, the partner connection system 100 facilitates co-selling between a vendor and various partners by establishing a controlled data exchange ecosystem. This enables near real-time visibility into relevant sales information, enabling both the vendor and the partners to collaboratively manage customer relationships through a metadata-driven architecture that allows for the selective sharing of critical data points, like deal stage, while maintaining confidentiality of sensitive information. The vendor and partners define the specific data to be exchanged, ensuring alignment and controlled access.

The exemplary architecture 100 can employ an event-based system, enabling automated responses to changes in shared data. For instance, if the vendor marks a deal as “at risk,” this event triggers an update in a partner, reflecting the agreed-upon shared information. This real-time data flow supports automated processes, such as scheduling meetings or initiating specific actions based on predefined rules or custom configurations. This flexibility allows both the vendor and the partner to tailor their responses to incoming events, enhancing their collaborative sales efforts. The exemplary partner connection system 100 further streamlines the vendor/partner relationship by automating authentication, managing user roles, and enabling selective data sharing to provide a platform for both parties to operate within their existing systems while leveraging shared insights for co-selling. The system can focus on the internal data exchange and event-driven automation between the vendor and partner, enabling them to improve their collaborative sales processes.

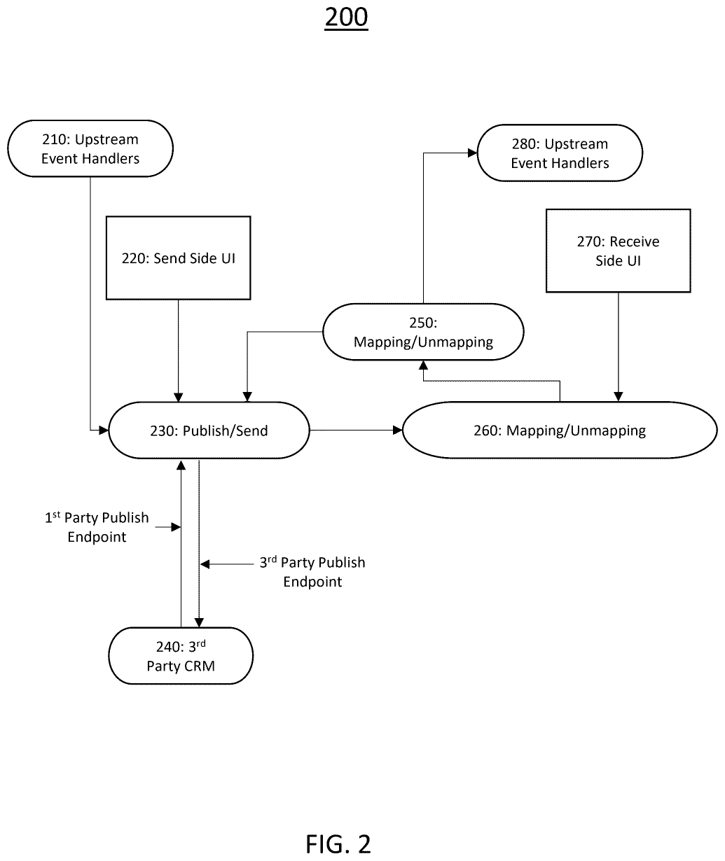

FIG. 2 depicts an exemplary partner connect architecture 200 that may be implemented or otherwise performed securely sharing data records with one or more partners. The partner connect architecture 200 can be event driven, employing a hub-and-spoke model with point-to-point event streams, facilitating a many-to-many ecosystem integration, enabling vendors to share CRM data with multiple partners.

An upstream event handler 210 can be employed to act as an intermediary, processing and reacting to real-time data events flowing through the event-based partner connect architecture 200. The upstream event handler 210 can subscribe to one or more specific event streams relevant to one or more business processes, filtering and transforming incoming data as needed. Upon receiving an event, the upstream event handler 210 can trigger predefined actions, such as updating local databases, initiating workflows, or invoking external APIs. This triggering allows for dynamic and responsive integration with other systems within the ecosystem. Crucially, the handler ensures data integrity and order, handles potential failures, and enables custom logic to be applied based on the event payload, effectively translating raw event data into actionable business outcomes. For ISVs, this facilitates seamless integration with partner ecosystems, while customers gain the ability to automate complex processes and derive real-time insights from interconnected systems.

An out-of-the-box (OOTB) send-side user interface (UI) 220 can be employed to provide a standardized interface for vendors to configure and manage the transmission of data or events to partner systems within an event-driven architecture. Functionally, it allows vendors to define the specific data fields, objects, or events to be shared, often through a visual interface that simplifies field mapping and selection. This UI can include features for setting transmission thresholds, defining event triggers, and managing authentication credentials for partner connections. Furthermore, it streamlines the process of customizing data payloads and defining the format of the transmitted information, ensuring compatibility with diverse partner systems. Essentially, the send-side UI empowers vendors with granular control over data dissemination, without requiring extensive coding, facilitating efficient and consistent information sharing across the ecosystem.

The publish/send process initiates with an upstream event handler that captures relevant data changes or actions, triggered by vendor interactions or system updates. This data is then channeled through the send-side UI, where vendors define the specific data elements and mapping rules, translating internal data structures to the partner-expected format. The mapping/unmapping process ensures accurate data transformation, handling complex field relationships and data type conversions. Subsequently, a 1st party publish endpoint, acting as an intermediary, generates a 3rd party publish endpoint. This endpoint facilitates the asynchronous or synchronous transmission of the formatted data onto the receiver's event bus. The choice between synchronous and asynchronous publishing depends on the real-time requirements and system constraints, with asynchronous ensuring non-blocking operations and synchronous guaranteeing immediate delivery.

A subscribe/receive process on the vendor's end operates in conjunction with the publish/send mechanism to retrieve the latest data. Upon receiving an event notification on their event bus, the partner's system utilizes a subscribe/receive process to pull the data from the designated 3rd party publish endpoint. This process typically involves authentication and authorization checks to ensure secure data access. The received data is then unmapped, reversing the vendor's mapping process to align with the partner's internal data model. This enables the partner to integrate the vendor's data into their systems, maintaining data consistency and leveraging the most up-to-date information shared by the vendor. This bi-directional communication ensures that both vendor and partner systems remain synchronized, facilitating collaborative workflows and data-driven decision-making.

The subscribe/receive process generates mapping/unmapping data by analyzing the metadata associated with the incoming event stream and comparing it against the partner's internal data schema. Upon subscription, the process retrieves the schema definition from the 3rd party publish endpoint or a metadata registry. This schema, defined by the vendor during the send-side mapping, is then analyzed to determine the necessary transformations for aligning the vendor's data structure with the partner's. The process creates mapping rules, often stored as configuration objects, that dictate how vendor fields should be translated to partner fields. Conversely, unmapping rules are generated to reverse this process, ensuring that data sent back to the vendor maintains its original structure. This metadata-driven approach allows for dynamic mapping/unmapping, adapting to schema changes without requiring manual adjustments.

Downstream processes leverage the mapping/unmapping configurations generated during the subscribe/receive stage to ensure seamless data integration and interoperability. Upon receiving data from the vendor's event stream, these processes apply the pre-defined mapping rules to transform the vendor's data structure into the partner's internal schema. This enables applications, databases, or analytical tools to consume and process the incoming data without requiring manual adjustments or custom code. Subsequently, when data needs to be sent back to the vendor or shared with other systems, the unmapping rules are applied to reverse the transformation, restoring the data to its original vendor-defined structure. This bi-directional transformation ensures data consistency and integrity across the ecosystem, facilitating data exchange and enabling downstream processes to operate on standardized data formats, regardless of the originating system's schema.

The subscribe/receive process also generates data for the receive-side UI by extracting relevant information from the incoming event stream and formatting it for display. This involves parsing the received data payload, which is often in a standardized format like JSON or XML, and extracting the fields specified in the mapping rules. The process then translates these fields into a user-friendly format, applying data type conversions and formatting rules as needed. This data is then structured into a format suitable for the receive-side UI, often as a set of key-value pairs or a structured object. The UI uses this data to display the received information, allowing partners to view and interact with the data shared by the vendor. This process ensures that the received data is presented in a clear and understandable manner, facilitating effective data consumption and analysis.

This architecture addresses the vendor's need for partner activity visibility without direct CRM access, crucial for co-vendor collaboration. Key features include automated authentication for rapid partner onboarding, guaranteed event order, plug-and-play compatibility between vendor and external systems, and vendor-controlled field mapping. By leveraging event-based triggers instead of data synchronization, vendors can customize information sharing thresholds, granting partners flexibility while maintaining vendor oversight. This setup enables effective partner connect capabilities, delivering essential insights into partner system interactions without compromising data integrity or requiring direct CRM access, preventing data overwrites and automating setup.

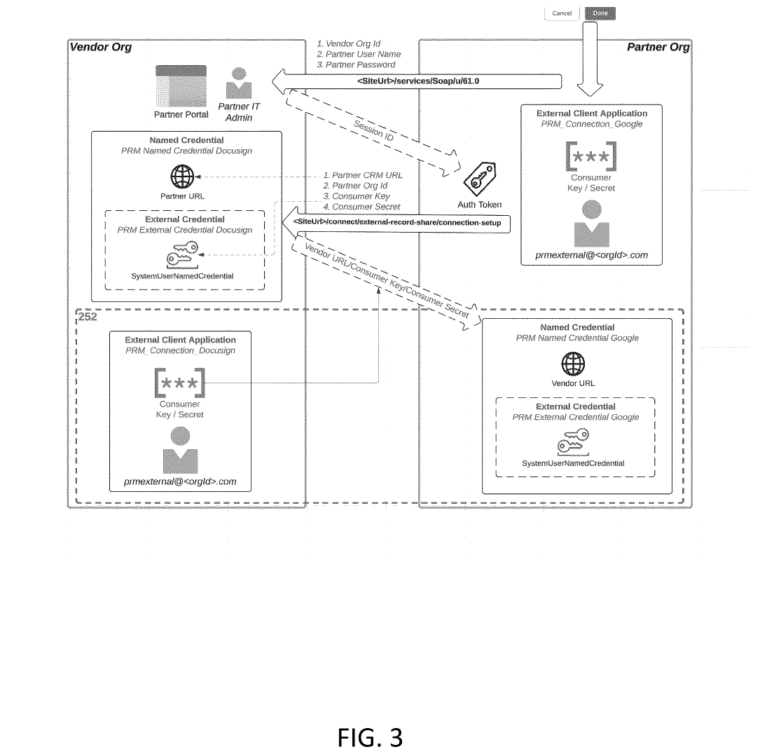

FIG. 3 depicts an exemplary authentication sequence 300 for a partner connect architecture that may be implemented or otherwise performed securely sharing data records with one or more partners. To facilitate secure and efficient record data exchange across disparate CRM systems, a robust authentication and authorization framework can be implemented. The authentication sequence 300 can involve the strategic integration and extension of native CRM platform functionalities. Specifically, Named Credentials can be leveraged for secure outbound connection establishment, while External Client Apps can be employed to manage inbound authorization. Automation of this integration process can be achieved through a streamlined system administrator setup interface, simplifying the configuration of bi-directional communication. In some exemplary embodiments, the resulting connection can be exclusively managed and utilized by a Partner Connect feature at runtime, ensuring secure and controlled data export and sharing. This solution can provide an automated, secure, and bi-directional connection between CRM systems, accessible solely through the Partner Connect feature, thus enhancing data interoperability while maintaining stringent security protocols.

The partner can first access 310 a vendor API. This can involve the steps of determining the root address of the API service, such as api.example.com. The vendor can next append the specific path to the desired API function or resource to the base URL. This indicates which part of the API requested to interact with, such as /data/users/. In some exemplary embodiments, some APIs can employ specific protocols like SOAP (XML-based) or REST (often JSON-based). The URL path can then indicate the protocol. Many APIs use versioning to manage changes. The vendor can then include the version number in the URL or headers to ensure compatibility. The base URL, endpoint, protocol identifier (if any), and version (if any) can then be combined to form a complete URL for the API request, such as api.example.com/data/users/v2. The vendor can next use query parameters (key-value pairs appended to the URL with a “?” and “&” separators) or request body data to specify additional information for the API call, such as vendor org ID, partner user name and/or partner password. The vendor can then send the request using an HTTP client (e.g., a web browser, curl, or a programming language's HTTP library) to the constructed URL.

In response to the partner request, the vendor API can return a response with a structured payload in order to facilitate secure session management. Upon successful validation of the partner's credentials, the vendor API can generate a unique session ID. This session ID can then be included within the response, such as a JSON web token (JWT) or within a dedicated session object. The response payload may also include an authentication token, which is a short lived credential that the partner application can then use in subsequent API calls. The session ID can act as a reference point for the vendor's server to track the partner's ongoing session. This allows the vendor to validate the partner's authentication token, by cross referencing the token with the session ID. This implementation ensures that the vendor can maintain session state, and also allows for the partner application to make authorized API calls, without needing to resubmit authentication credentials on every request.

Following successful partner authentication and session establishment, the partner API, upon receiving a request to initiate external record sharing, can respond with a payload containing the necessary connection parameters. This response typically includes the partner's CRM URL, specifying the endpoint for subsequent data exchange. It also furnishes the Partner ORG ID, a unique identifier for the partner's organizational instance within their CRM. Furthermore, the response delivers the customer key and customer secret, which serve as OAuth 2.0 credentials or similar authorization tokens, enabling the vendor to authenticate and authorize data access to the partner's CRM. The customer secret is a confidential string of characters used in conjunction with the client ID to authenticate an application or user when accessing an API or other protected resource. These credentials are employed for establishing a secure, bi-directional data flow, allowing the vendor to read and potentially write data within the partner's CRM environment, facilitating seamless record sharing and integration.

Upon receiving the partner's CRM URL, Partner ORG ID, consumer key, and consumer secret, the vendor leverages these credentials to establish a secure connection and access the Partner Relationship Management (PRM) system. The vendor's application utilizes the consumer key and secret in an OAuth 2.0 or similar authorization flow to obtain an access token from the partner's authorization server. This access token, validated against the Partner ORG ID, grants the vendor's application the necessary permissions to interact with the PRM's external credential and external client application resources. The partner's CRM URL serves as the endpoint for API calls, facilitating data exchange and interaction. Through this process, the vendor is able to securely access and manage the external credentials and client applications within the partner's PRM environment, enabling authorized data sharing and integration.

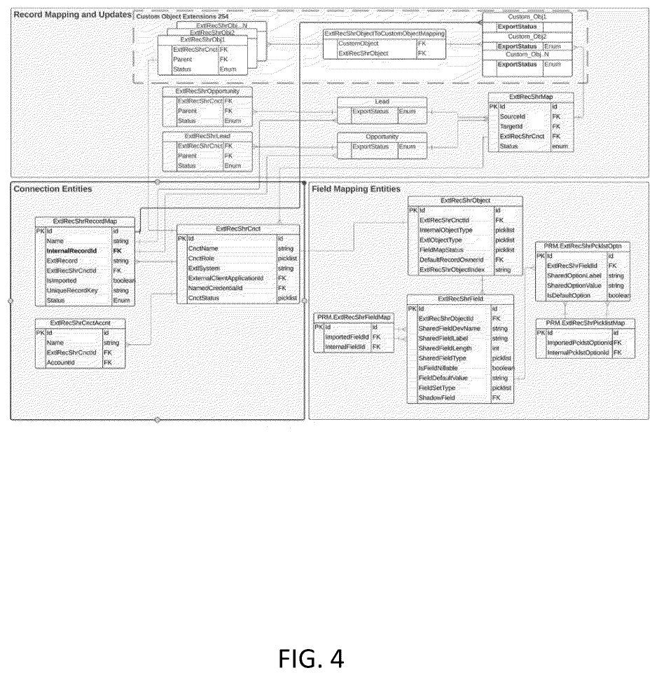

Referring to FIG. 4, a data structure 400 illustrating relationships and attributes of data entities for an exemplary partner connect architecture that may be implemented or otherwise performed securely sharing data records with one or more partners. The exemplary data structure 400 is configured to facilitate bi-directional data sharing between vendors and partners by enabling granular field selection and mapping. In some exemplary embodiments, vendors define shareable fields, such as strings, numbers, dates, and picklists, from supported objects, while partners map these incoming fields to their corresponding record fields. At runtime, the system enforces these configurations: vendors restrict data exports to selected fields, and partners translate incoming data via defined mappings. This functionality operates symmetrically, allowing partners to share data with vendors using reversed roles and ensures controlled data exchange based on pre-defined agreements. The exemplary data structure 400 can be organized into three primary sections: Record Mapping and Updates Custom Object Extensions 410, Connection Entities 420, and Field Mapping Entities 430.

Record Mapping and Updates Custom Object Extensions 410 highlights the linkage between external record sharing objects (e.g., ExtlRecShrObj1, ExtlRecShrOpportunity, ExtlRecShrLead) and custom objects (Custom Obj1, Custom Obj2, Custom Obj N) through the ExtlRecShrObjectToCustomObjectMapping entity. The ExportStatus enum can be employed to track the success or failure of data export operations. This mapping facilitates the transfer of data between external and internal system representations by allowing the system to define how external users can access specific records, extend the sharing rules to include custom data stored in custom objects, maintain a clear and organized relationship between standard sharing objects and custom objects. This allows the system to update the custom objects based upon changes to the external record sharing objects. This mapping further enhances data security, making sure that external users only have access to the data that they are supposed to.

Connection Entities 420 manages the connections between external and internal systems. The core entity is ExtlRecShrCnct, which stores connection details like CnctName, CnctRole, ExtlSystem, ExternalClientApplicationId, NamedCredentialId, and CnctStatus. This entity is linked to ExtlRecShrRecordMap, which maps individual records between the two systems, using attributes like InternalRecordId, ExtlRecord, and UniqueRecordKey. The ExtlRecShrCnctAccont entity establishes a relationship between a connection and an account, potentially for tracking account-specific connection details. The Status enum in ExtlRecShrRecordMap can indicate the current state of the record mapping process (e.g., pending, completed, error).

Field Mapping Entities 430 can be used to define how fields are mapped between external and internal objects. The Field Mapping Entities 430 can store selected fields and mapping configurations. Changes to these configurations can be “direct” (admin-initiated) or “indirect” (schema changes). Indirect changes trigger notifications to admins, ensuring data integrity. Field mapping occurs close to the data source, with owners responsible for mapping operations. Selected fields act as a contract, necessitating updates upon modifications. The data model utilizes CosellSharedObject linked to AuthenticationData, with a focus on bi-directional data flow. The central entity, ExtlRecShrObject, specifies the internal object type and its corresponding external object type, along with status and index information. The PRM ExtlRecShrFieldMap entity maps individual fields, using ImportedFieldId and InternalFieldId to link fields across systems. Attributes like SharedFieldDevName, SharedFieldLabel, SharedFieldLength, SharedFieldType, and IsFieldNillable define the characteristics of the mapped fields. The PRM ExtlRecShrPicklistMap entity handles the mapping of picklist options, associating ImportedPicklistOptionId with InternalPicklistOptionId. The PRM ExtlRecShrPcklstOpt entity can be used to store the available options for picklist fields, with attributes like SharedOptionLabel and SharedOptionValue.

In some exemplary embodiments, foreign keys can be used to establish relationships between entities, enabling data integrity and efficient querying. Enums can be used to define a set of predefined values for certain attributes, ensuring data consistency. The data structure 400 can be used to manage the complex process of mapping records and fields between external and internal systems, facilitating data synchronization and integration. The inclusion of status tracking and detailed field mapping information suggests a robust and well-designed system for managing data exchange. Runtime export and update processes leverage the defined field selections and mappings to ensure accurate data transfer. Bi-directional data exchange uses a platform event for metadata transfer, automating the sharing of field selections and mapping states. De-duplication and conflict resolution mirror record data handling. To prevent data collisions, vendors specify updatable fields for both parties, enforcing mutual exclusivity. This is implemented via a field updatableBy enum within the field BPO, enhancing control over data modifications.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

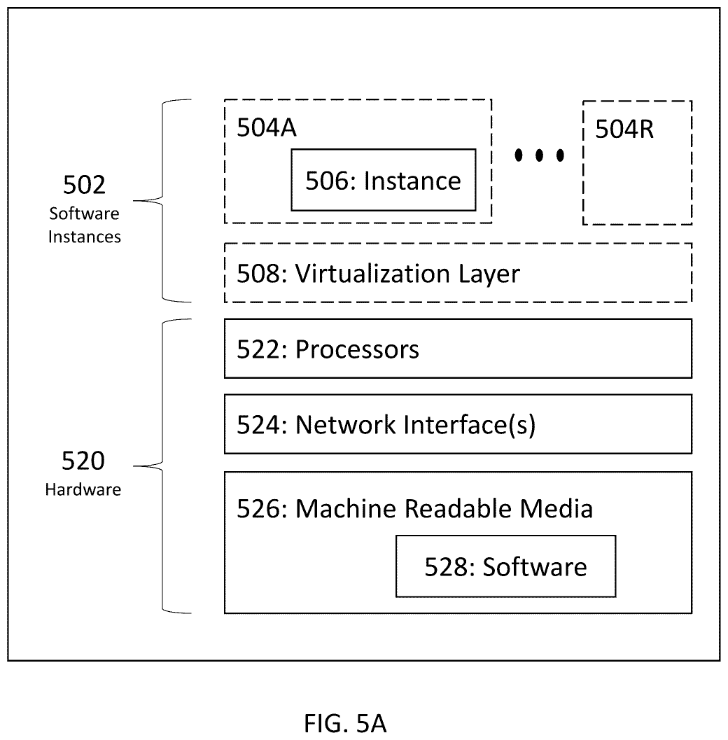

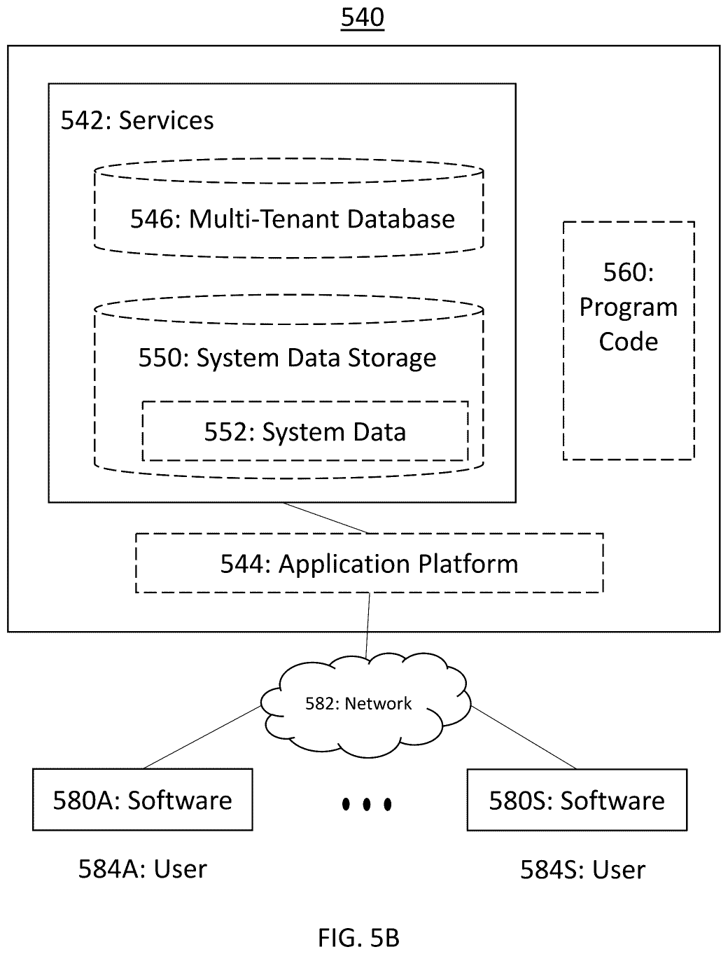

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described clients and the secure sharing service may be implemented in one or more electronic devices 500. In one implementation, each of the clients is implemented in a separate one of the electronic devices 500 (e.g., in end user devices where the software 528 represents the software to implement clients to interface directly and/or indirectly with the secure sharing service (e.g., software 528 represents a web browser, a native client, a portal, a command-line interface, and/or an application programming interface (API) based upon protocols such as Simple Object Access Protocol (SOAP), Representational State Transfer (REST), etc.)); Next, the secure sharing service is implemented in a separate set of one or more of the electronic devices 500 (e.g., a set of one or more server devices where the software 528 represents the software to implement the secure sharing service); and in operation, the electronic devices implementing the clients and the secure sharing service would be communicatively coupled (e.g., by a network) and would establish between them (or through one or more other layers and/or or other services) connections for submitting requests and/or making API calls to the secure sharing service. Other configurations of electronic devices may be used in other implementations (e.g., an implementation in which the client and the secure sharing service are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-504R (e.g., with operating system-level virtualization, the virtualization layer 508 may represent a container engine (such as Docker Engine by Docker, Inc. or rkt in Container Linux by Red Hat, Inc.) running on top of (or integrated into) an operating system, and it allows for the creation of multiple software containers 504A-504R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-504R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-504R if implemented, are collectively referred to as software instance(s) 502.

Alternative implementations of an electronic device may have numerous variations from that described above. For example, customized hardware and/or accelerators might also be used in an electronic device.

FIG. 5B is a block diagram of a deployment environment according to some example implementations. A system 540 includes hardware (e.g., a set of one or more server devices) and software to provide service(s) 542, including the secure sharing service (e.g., to support one or more of the above-described processes). In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 540 is coupled to user devices 580A-580S over a network 582. The service(s) 542 may be on-demand services that are made available to one or more of the users 584A-584S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-584S). The service(s) 542 may communicate with each other and/or with one or more of the user devices 580A-580S via one or more APIs (e.g., a REST API). In some implementations, the user devices 580A-580S are operated by users 584A-584S, and each may be operated as a client device and/or a server device. In some implementations, one or more of the user devices 580A-580S are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors'data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 540 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 540 may include an application platform 544 that enables PAAS for creating, managing, and executing one or more applications developed by the provider of the application platform 544, users accessing the system 540 via one or more of user devices 580A-580S, or third-party application developers accessing the system 540 via one or more of user devices 580A-580S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-580S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-580S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers'creation and management of applications, which may be saved as metadata by save routines. Invocations to such applications, including the secure sharing service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 6^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580A-580S.

Each user device 580A-580S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-584S to interact with various GUI pages that may be presented to the one or more of users 584A-584S. User devices 580A-580S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-580S might include an HTTP client, commonly referred to as a “browser,” for sending and receiving HTTP messages to and from server(s) of system 540, thus allowing users 584A-584S of the user devices 580A-580S to access, process and view information, pages and applications available to it from system 540 over network 582.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A computer-implemented customer relationship management (CRM) system
comprising:
a hub-and-spoke architecture configured to facilitate bidirectional connections between a first vendor and a second vendor, wherein the second vendor functions as a partner on a spoke to the first vendor functioning as a hub;
an event-based architecture configured to transmit data between the first vendor and the second vendor based on a predefined event;
a metadata sharing module configured to share authorized organizational metadata between the first vendor and the second vendor, wherein the metadata sharing module enables the first vendor to submit a request for access to one or more requested data fields from the second vendor, enables the second vendor to approve the request, to identify one or more corresponding data fields corresponding to the one or more requested data fields, and to enables the second vendor to grant access to the first vendor to the one or more corresponding data fields; and
an integration module configured to integrate the one or more corresponding data fields into the CRM system.

2. The computer-implemented customer relationship management system of claim 1 further including an automated authentication module configured to establish a secure connection between the first vendor and the second vendor, wherein the authentication module limits an authentication scope to a specific connection and a data sharing process, and to prevent unauthorized access to one or more application programming interfaces.

3. The computer-implemented customer relationship management system of claim 1, wherein:
integrating the one or more corresponding data fields includes retrieving, from the second vendor over a communications network, values for a subset of fields of a data record that are common to both a first subset of fields of the data record and a second subset of fields of the data record; and
automatically generating a shared data record message including the values retrieved for the subset of fields of the data record within a conversation at a communication platform.

4. The computer-implemented customer relationship management system of claim 1, wherein the one or more corresponding data fields are read only data fields and wherein a copy of the one or more corresponding data fields are integrated into the CRM system.

5. The computer-implemented customer relationship management system of claim 1, further including a third vendor and wherein the metadata sharing module enables the first vendor to submit a supplemental request for access to one or more supplemental data fields from the third vendor, enables the third vendor to approve the supplemental request, to identify one or more corresponding supplemental data fields corresponding to the one or more supplemental data fields, and to enables the third vendor to grant access to the first vendor to the one or more supplemental data fields, and wherein the integration module is further configured to integrate the one or more supplemental data fields into the CRM system.

6. The computer-implemented customer relationship management system of claim 1, wherein the event-based architecture configured to transmit data between the second vendor and the first vendor based on a second predefined event associated with the second vendor.

7. The computer-implemented customer relationship management system of claim 1, further including an upstream event handler to detect the predefined event and to trigger a predefined action including at least one of updating a local database, initiating a workflow and invoking an external application programming interface in response to the detection of the predefined event.

8. The computer-implemented customer relationship management system of claim 1, wherein upon approving the request for access, the second vendor can return a response with a structured payload including a credential.

9. The computer-implemented customer relationship management system of claim 1 further including a send side user interface configured to allow the first vendor to manage a transmission of the request for access, and allows at least one of the first vendor and the second vendor to define the one or more requested data fields and the one or more corresponding data fields.

10. A non-transitory machine-readable storage medium that provides instructions that, when executed by a processor, are configurable to cause said processor to perform operations comprising:
facilitate bidirectional connections between a first vendor and a second vendor in a hub-and-spoke configuration, wherein the second vendor functions as a partner on a spoke to the first vendor functioning as a hub;
transmitting data, by an event-based architecture, between the first vendor and the second vendor based on a predefined event;
sharing authorized organizational metadata, by a metadata sharing module, between the first vendor and the second vendor, wherein the metadata sharing module enables the first vendor to submit a request for access to one or more requested data fields from the second vendor, enables the second vendor to approve the request, to identify one or more corresponding data fields corresponding to the one or more requested data fields, and to enables the second vendor to grant access to the first vendor to the one or more corresponding data fields; and
integrating, by an integration module, the corresponding data fields into a customer relationship management system.

11. The non-transitory machine-readable storage medium of claim 10, wherein the instructions are configurable to cause the processor to:
establish a secure connection between the first vendor and the second vendor, and to limit an authentication scope to a specific connection and a data sharing process, and to prevent unauthorized access to one or more application programming interfaces.

12. The non-transitory machine-readable storage medium of claim 10, wherein the instructions are configurable to cause the processor to:
integrate the one or more corresponding data fields includes retrieving, from the second vendor over a communications network, values for a subset of fields of a data record that are common to both a first subset of fields of the data record and a second subset of fields of the data record; and
automatically generate a shared data record message including the values retrieved for the subset of fields of the data record within a conversation at a communication platform.

13. The non-transitory machine-readable storage medium of claim 10, further including a third vendor and wherein the metadata sharing module enables the first vendor to submit a supplemental request for access to one or more supplemental data fields from the third vendor, enables the third vendor to approve the supplemental request, to identify one or more corresponding supplemental data fields corresponding to the one or more supplemental data fields, and to enables the third vendor to grant access to the first vendor to the one or more supplemental data fields, and wherein the integration module is further configured to integrate the one or more supplemental data fields into the CRM system.

14. The non-transitory machine-readable storage medium of claim 10, wherein the instructions are configurable to cause the processor to transmit data between the second vendor and the first vendor based on a second predefined event associated with the second vendor.

15. The non-transitory machine-readable storage medium of claim 10, wherein the instructions are configurable to cause the processor to detect the predefined event and to trigger a predefined action including at least one of updating a local database, initiating a workflow and invoking an external application programming interface in response to the detection of the predefined event.

16. The non-transitory machine-readable storage medium of claim 10, wherein the instructions are configurable to cause the processor to receive a response from the second vendor with a structured payload including a credential in response to approving the request.

17. The non-transitory machine-readable storage medium of claim 10, wherein the instructions are configurable to cause said processor to allow the first vendor to manage a transmission of the request or access, and to allow at least one of the first vendor and the second vendor to define the one or more requested data fields and the one or more corresponding data fields.

18. The non-transitory machine-readable storage medium of claim 10, wherein the one or more corresponding data fields are read only data fields and wherein a copy of the one or more corresponding data fields are integrated into the CRM system.

19. A method of performing a first customer relationship management function comprising:
facilitating a bidirectional connection between a first vendor and a second vendor, wherein the second vendor functions as a partner;
transmitting data between the first vendor and the second vendor based on a predefined event;
sharing authorized organizational metadata between the first vendor and the second vendor, including enabling the first vendor to submit a request for access to one or more requested data fields from the second vendor, enabling the second vendor to approve the request, identifying one or more corresponding data fields corresponding to the one or more requested data fields, and enabling the second vendor to grant access to the first vendor to the one or more corresponding data fields; and
integrating the one or more corresponding data fields into a customer relationship management system metadata associated with the first customer relationship management function.

20. The method of performing a first customer relationship management function of claim 19, comprising:
establishing a secure connection between the first vendor and the second vendor;
limiting an authentication scope to a specific connection and a data sharing process;
preventing unauthorized access to one or more application programming interfaces;
integrating the one or more corresponding data fields includes retrieving, from the second vendor over a communications network, values for a subset of fields of a data record that are common to both a first subset of fields of the data record and a second subset of fields of the data record; and
automatically generating a shared data record message including the values retrieved for the subset of fields of the data record within a conversation at a communication platform.
